(19) United States
(12) Patent Application Publication
(10) Pub. No.: US 2022/0256429 A1
(43) Pub. Date: Aug. 11, 2022

(54) SYSTEM FOR MULTI-PATH 5G AND WI-FI MOTION DETECTION

(71) Applicant: Aerial Technologies Inc., Montreal (CA)

(72) Inventors: Michel Allegue Martinez, Terrebonne (CA); David Grant, Santa Rosa Valley, CA (US)

(21) Appl. No.: 17/730,940

(22) Filed: Apr. 27, 2022

Related U.S. Application Data
(63) Continuation of application No. PCT/IB2020/060271, filed on Nov. 2, 2020.
(60) Provisional application No. 62/929,240, filed on Nov. 1, 2019.

(51) Int. Cl. H04W 36/32; H04W 36/24; H04W 36/00

(52) U.S. Cl. CPC H04W 36/32; H04W 36/00835; H04W 36/00837; H04W 36/245

(57) ABSTRACT

A system for location detection is provided that includes a device that is disposed within a detection environment and is adapted to communicate over a radio frequency communication link. The device may be a wireless access point disposed within the environment, including a wireless transceiver in communication with the device over a radio frequency communication link using a plurality of channels, and recording a channel state information data set for the radio frequency communication link. The wireless access point Wi-Fi signal is used to detect motion within the detection environment. The system further integrates with 5G networks to allow motion and location tracking outside of the detection environment and range of the Wi-Fi motion detection system by using the 5G CSI data on a mobile station, such as a mobile device.

### CROSS REFERENCE TO RELATED APPLICATIONS

The present application is a continuation and claims the priority benefit of international application PCT/IB2020/060271 filed Nov. 2, 2020, which claims the priority benefit of U.S. provisional patent application 62/929,240 filed Nov. 1, 2019, the disclosures of which are incorporated by reference in their entirety.

### BACKGROUND OF THE INVENTION

### 1. Field of the Invention

The present disclosure relates to the integration of 5G network technology into a Wi-Fi motion detection system. More specifically, the present disclosure relates to enhancing the range and ability of the Wi-Fi motion detection system for tracking users.

### 2. Description of the Related Art

Motion detection is the process of detecting a change in the position of a user or object relative to its surroundings or a change in the surroundings relative to the user or object. Motion detection is usually a software-based monitoring algorithm executable, for example, to detect motion and to signal a surveillance camera to begin capturing the event. An advanced motion detection surveillance system can analyze the type of motion and determine whether such motion may warrant an alarm. A Wi-Fi motion detection system is normally able to determine motion within a certain range or area.

Activity recognition is predicting or recognizing the movement of a user, often indoors, based on sensor data, such as an accelerometer in a smartphone or distortions of wireless signals. Activity recognition aims to recognize and predict the actions and goals of one or more users from a series of observations on the user actions and the environmental conditions. Due to its many-faceted nature, different fields may refer to activity recognition as plan recognition, goal recognition, intent recognition, behavior recognition, location estimation, and location-based services. Wi-Fi location determination, also known as Wi-Fi localization or Wi-Fi location estimation refers to methods of translating observed Wi-Fi signal strengths into locations.

There is therefore a need in the part for improved systems and methods of 5G and Wi-Fi motion detection

### SUMMARY OF THE INVENTION

Embodiments of the present disclosure provide a multi-path means of tracking a user outside of a Wi-Fi motion detection system range by leveraging a 5G network. A Wi-Fi motion detection system range or detection environment is monitored for one or more mobile devices. The one or more mobile devices in the detection environment are registered and analyzed for capabilities. The one or more mobile devices may communicate with the system when the one or more mobile devices leaves the detection environment. The system may determine when the one or more mobile devices has left or is leaving the environment. The location of the mobile devices may be monitored after leaving the detection environment. The system may then collect sensor data and other data from the mobile devices while outside of the detection environment and store the sensor data and other data in a database.

### BRIEF DESCRIPTIONS OF THE DRAWINGS

FIG. 1 illustrates an exemplary network environment in which a system for Wi-Fi radio motion detection may be implemented.

FIG. 2 is a flowchart illustrating an exemplary method for Wi-Fi radio motion detection.

FIG. 3 is a flowchart illustrating an exemplary method for agent handshakes.

FIG. 4 is a flowchart illustrating an exemplary method for cloud handshakes.

FIG. 5 is a flowchart illustrating an exemplary mobile device method for Wi-Fi radio motion detection.

FIG. 6 is a flowchart illustrating an exemplary method for mobile device handshakes.

FIG. 7 is a flowchart illustrating an exemplary method for mobile device motion analysis.

### DETAILED DESCRIPTION

Exemplary embodiments of the present invention may extends the range and capability of the Wi-Fi motion detection system and allows detection outside of a home or other environment, such as a factory or office. Embodiments of the present disclosure allows continuous data transfer and tracking to accurately and quickly switch from Wi-Fi to 5G and back when a user moves outside or into the Wi-Fi motion detection system range or detection environment. In another example, a mobile station using 5G could be used to detect activity and occupants of the mobile station. The 5G channel state information (CSI) data could be used on a connected vehicle to detect activities near or around the vehicle and within the vehicle (e.g., activities of the occupants of the vehicle).

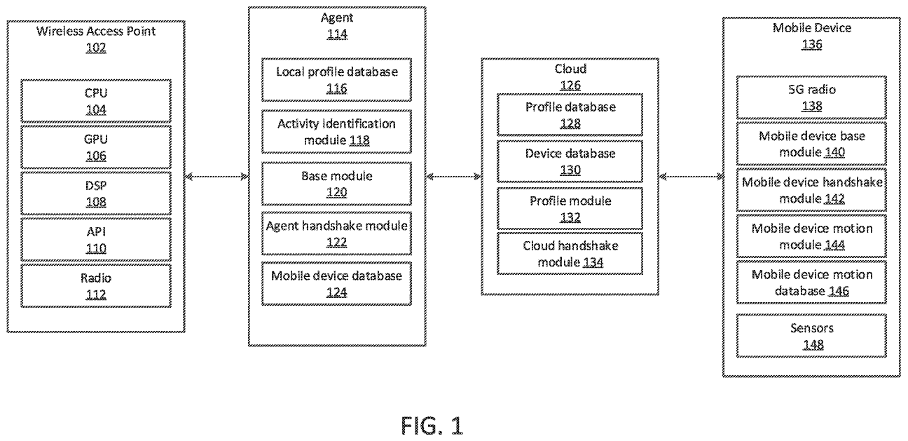

FIG. 1 illustrates an exemplary network environment in which a system for Wi-Fi radio motion detection may be implemented. The network environment includes a wireless access point 102 (e.g., Wi-Fi access point). In an embodiment, the wireless access point 102 is configured to comply with IEEE standards 802.11n, 802.11ac, or above. The wireless transceiver of the wireless access point 102 is in communication with a further stationary device over a corresponding radio frequency communication link. The wireless access point 102 is configured to record a further channel state, frequency response, or impulse response information data set for at least one radio frequency communication link at a corresponding time. In an embodiment, determining the activity of the person in the environment includes determining the activity of the person in the environment based on a comparison of further channel state information, frequency response, or impulse response of the channel data set to each of the at least one channel state information, or frequency or impulse response of the channel profiles of each of the plurality of activity profiles. In an embodiment, the activity is determined based on a sum of a similarity measurement of the channel state information, or impulse or frequency response of the channel data set and a similarity measurement of the further channel state information, or impulse or frequency response of the channel data set.

A central processing unit (CPU) 104 is the electronic circuitry within a computer that carries out the instructions of a computer program by performing the basic arithmetic, logic, controlling and input/output (I/O) operations specified by the instructions. A graphics processing unit (GPU) 106 is a specialized electronic circuit designed to rapidly manipulate and alter memory to accelerate the creation of images in a frame buffer intended for output to a display device. GPUs 106 are used in embedded systems, mobile phones, personal computers, workstations, and game consoles. GPU 106 may manipulate computer graphics and image processing and process large blocks of data in parallel. A digital signal processor (DSP) 108 is a specialized microprocessor (or a SIP block), with its architecture optimized for the operational needs of digital signal processing. The DSP 108 is used to measure, filter, or compress continuous real-world analog signals. An application program interface (API) 110 is a set of routines, protocols, and tools for building software applications. The API 110 specifies how software components should interact is used when programming graphical user interface (GUI) components. The API 110 provides access to the channel state data to the agent 114. An access point 102 compliant with either 802.11 ac, 802.11n, or above allows for multiple antennas. Multiple antennas from a radio 112 enable the equipment to focus on the far end device, reducing interference in other directions and giving a stronger useful signal. This greatly increases range and network speed without exceeding the legal power limits.

An agent 114 is configured to collect data from the Wi-Fi chipset, filter and pass the incoming data to the cloud server 126 for activity identification. Depending on the configuration, the activity identification can be done on the edge, at the agent 114 level, in the cloud 126, or some combination of the two. A local profile database 116 is utilized when at least a portion of the activity identification is done on the edge. This could be a simple motion/no-motion determination profile, or a plurality of profiles for identifying activities, objects, individuals, biometrics, etc. An activity identification module 118 distinguishes between walking activities and in-place activities. In general, a walking activity causes significant pattern changes of the channel state information (CSI), or impulse or frequency response of the channel amplitude over time, since such activity involves significant body movements and location changes. In contrast, an in-place activity (e.g., watching TV on a sofa) only involves relative smaller body movements that may be captured through small distortions on magnitude and/or of CSI. The agent 114 may be associated with the wireless access point 102 or another computing device (e.g., server) in communication with the wireless access point 102.

The base module 120 monitors the Wi-Fi signal of the wireless access point 102 for the presence of any mobile devices 136 that are detected within a surrounding environment of the Wi-Fi motion detection system. If a mobile device 136 is detected, the mobile device 136 may be checked if the mobile device 136 is registered in the device database 130 and has 5G capabilities. The agent handshake module 122 is then executed by the base module 120. The base module 120 continues to monitor for a message from the cloud handshake module 134 to determine when the mobile device 136 has returned to the detection environment.

The agent handshake module 122 monitors registered mobile devices 136 and their location within a Wi-Fi motion detection environment. If the mobile device 136 is found to be moving outside the detection environment, the cloud handshake module 134 is executed. A signal is sent to the mobile device base module 140 on the mobile device 136 that the mobile device 136 is leaving the Wi-Fi motion detection environment and to switch over to the 5G network monitoring. In another embodiment, the mobile device 136 could monitor the Wi-Fi signal strength, send a signal to the agent handshake module 122 that the mobile device 136 is leaving the detection environment, and activates the cloud handshake module 134. The agent handshake module 122 knows when a user or device is leaving and preemptively switches the mobile device 136 over to 5G to prevent data or packet loss due to dropped or weak signals.

The mobile device database 124 contains a list of the registered mobile devices 136 that are or have been connected to the environment of the Wi-Fi motion detection system. The mobile device database 124 stores a list of the devices 136 and their specifications. The mobile device database 124 contains the data for all registered mobile devices 136, including the device model and a unique ID for the mobile device 136, such as a MAC address or other unique identifier. The mobile device database 124 further contains data related to the user of the mobile device 136, including but not limited to the user name, and if the user opts-in or out of the multi-path tracking data transfer system. Table 1 (provided below) illustrates an exemplary mobile device database 124.

TABLE 1

| Mobile ID | User | Device Model | 5G? | Opt In? |
|---|---|---|---|---|
| 09:54:46:BC:C2:66 | John Smith | iPhone 10 | Yes | Yes |
| CF:77:AC:05:D3:6B | Jane Doe | Samsung s10 | Yes | Yes |
| 2D:5A:D3:9E:89:B3 | Mike Johnson | Samsung Note 8 | No | No |
| 9C:9E:A6:86:16:C3 | Bob Frank | iPhone 11 | Yes | No |
| 7A:D3:A4:DC:E6:B0 | Stacy Samson | 5G Spectrum | Yes | Yes |

The system can then determine which mobile devices 136 have the capabilities required, such as 5G. The cloud 126 analyzes and creates profiles describing various activities. The profile module 132 monitors the data set resulting from continuous monitoring of a target environment, to identify multiple similar instances of an activity without a matching profile in such a data set, combine that data with user feedback to label the resulting clusters to define new profiles that are then added to the profile database. A profile database 128 is utilized when at least a portion of the activity identification is done in the cloud 126. This could be a simple motion/no-motion determination profile, or a plurality of profiles for identifying activities, objects, individuals, biometrics, etc.

A device database 130 stores the device ID of all connected wireless access points 102. A profile module 132 monitors the data set resulting from continuous monitoring of a target environment, to identify multiple similar instances of an activity without a matching profile in such a data set, combine that data with user feedback to label the resulting clusters to define new profiles that are then added to the profile database 128. The cloud handshake module 134 is executed by the agent handshake module 122 when a mobile device 136 is determined to be leaving the detection environment of a Wi-Fi motion detection system. The cloud handshake module 134 then connects to the same 5G network that the mobile device 136 is connected to. Once the mobile device 136 is located on the 5G network the system can now start to collect sensor data from the mobile device 136 such as movement from an accelerometer. The location of the mobile device 136 can further be determined using a method to triangulate a signal. Any data transfer is switched over to the 5G network prior to Wi-Fi signal loss, which prevents lost data or packets.

The mobile device 136 is any portable computing device such as a smartphone, tablet, or wearable device. These mobile devices 136 may incorporate Wi-Fi radios including a 5G radio 138 for communicating over a 5G network. In another embodiment, the mobile device 136 may be a mobile station such as a connected vehicle.

The mobile device base module 140 continuously monitors the signal strength of the Wi-Fi signal as well as monitoring for signal from the agent handshake module 122. If the Wi-Fi signal strength goes below a specific threshold or a signal is received from the agent handshake module 122, the mobile device base module 140 executes the mobile device motion module 144 at element 140. The mobile device handshake module 142 monitors for a message from the cloud handshake module 134 over a 5G signal. The mobile device handshake module 142 executes the mobile device motion module 144 once the base module 120 executes the mobile device handshake module 142.

The mobile device motion module 144 monitors and stores sensor data from the sensors 148, such as accelerometer data, heart rates, etc. The mobile device motion module 144 is used to process and detect activities of motion in proximity to the mobile device 136. This is done by processing the 5G CSI data on the mobile devices 136 and then sending via a wireless network such as a 5G network to the cloud 126 for further processing.

Collected data is then stored in the mobile device motion database 146. The mobile device motion database 146 stores all of the motion data collected from the sensors 148 on the mobile device 136. For example, position information from GPS, accelerometer data, heart rate data, and time and date information. The mobile device motion database 146 contains data from the sensors 148 that are collected and stored by the mobile device motion module 144 including, but not limited to, accelerometer data, temperature, optical data, audio data, GPS data regarding position or location (e.g., latitude and longitude), and 5G CSI data from the mobile device 136. Table 2 (provided below) illustrates an exemplary mobile device motion database 146.

TABLE 2

| | | Accel. | Accel. | Accel. | | | | Location | Location |
|---|---|---|---|---|---|---|---|---|---|
| Time | Date | X | Y | Z | Temp. | Optical | Audio | (Latitude) | (Longitude) |
| 1:00 PM | Jul. 30, 2019 | +1.02 | −0.25 | +0.15 | 75° F. | O1.dat | A1.dat | 44.461586 | −73.1230225 |
| 1:01 PM | Jul. 30, 2019 | +0.35 | +0.25 | +0.03 | 75° F. | O2.dat | A2.dat | 44.461587 | −73.1230225 |
| 1:02 PM | Jul. 30, 2019 | +0.25 | −0.25 | −0.25 | 76° F. | O3.dat | A3.dat | 44.461588 | −73.1230226 |
| 1:03 PM | Jul. 30, 2019 | −0.15 | +0.25 | −1.01 | 76° F. | O4.dat | A4.dat | 44.461589 | −73.1230226 |
| 1:04 PM | Jul. 30, 2019 | +1.11 | −0.00 | +0.20 | 77° F. | O5.dat | A5.dat | 44.461590 | −73.1230226 |

The sensors 148 on the mobile devices 136 can be inclusive of any number of sensors known in the art (e.g., accelerometers, heart rate sensors, GPS). The type and quantity of sensors 148 on a mobile device 136 can vary depending on the type of device. For example, a wearable device may have an accelerometer and heart rate sensors, while a smartphone may incorporate the accelerometer and optical data but may not have a heart rate sensor.

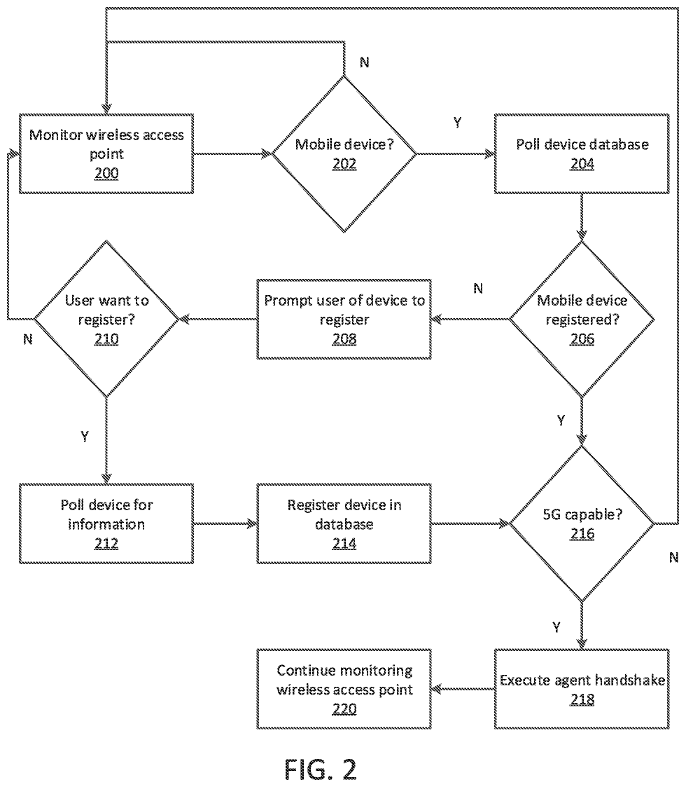

FIG. 2 is a flowchart illustrating an exemplary method for Wi-Fi radio motion detection. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The process of FIG. 2 begins with base module 120 monitoring for new activity or device and the type of device on the wireless access point 102 at step 200. If no new activity or device is detected at step 202, the module goes back to step 200 and continues to monitor. If new activity and new devices are detected, the device database 130 is polled at step 204 to determine if the mobile device 136 is already registered. A mobile device 136 needs to be registered to determine the capabilities of the mobile device 136, the type of device, and compatibility. At step 206, it may be determined whether the new mobile device 136 is registered in the device database 130. If the new mobile device 136 is not registered in the device database 130, the module can go to step 208 and the user of the mobile device 136 can be prompted to register the mobile. If the new device is already registered, the module can skip to step 216 and check the device database 130 for compatibility. For example, the module can check the device database 130 to determine if the device 136 has 5G capabilities.

At step 210, if the user elects not to register, a unique identification is created for the mobile device 136, and stored in the device database 130 as not wanting to register. The unique identification may be a MAC address available to a Wi-Fi network when a mobile device 136 connects to the network. If the mobile device 136 connects to the network in the future, the mobile device 136 may be identified as having elected not to register. If the user elects to register the base module 120, the mobile device 136 may be polled at step 212 for all relevant information, including identifying the mobile device 136 (e.g., MAC address, information related to the capabilities of the mobile devices 136, such as type of radio, processor, memory, etc.). The mobile device 136 is then registered in the device database 130 by storing the polled data from the mobile device 136 in the device database 130 at step 214.

Once a mobile device 136 has been determined to be registered or has just been registered, the base module 120 determines if the mobile device 136 has the required capabilities to work efficiently with the system at step 216. For instance, it may be determined if the mobile device 136 is equipped with a 5G radio 138. If the mobile device 136 does not have a 5G radio 138, such mobile device 136 may not operate efficiently with the system, and as such, the base module 120 may return step 200 to monitor for new devices. If the mobile device 136 is compatible with the system, the base module 120 then executes the agent handshake module 122 at step 218. The agent handshake module 122 continues to monitor the registered device and its location within the Wi-Fi environment at step 220 and determines if the mobile device 136 is moving outside of the Wi-Fi device environment in order to maintain accurate location of the mobile device 136 and to understand when data channels should be switched from moving over Wi-Fi to 5G or other cellular networks. Instead of the mobile device 136 waiting until a Wi-Fi signal is lost, the system may preemptively determine that a user or mobile device 136 is leaving, for example, a building and switch the data flow to 5G, not waiting a low or lost Wi-Fi signal which could produce lost packets or data. Once the agent handshake module 122 is executed, the base module 120 returns to monitoring the wireless access point 102 for new devices.

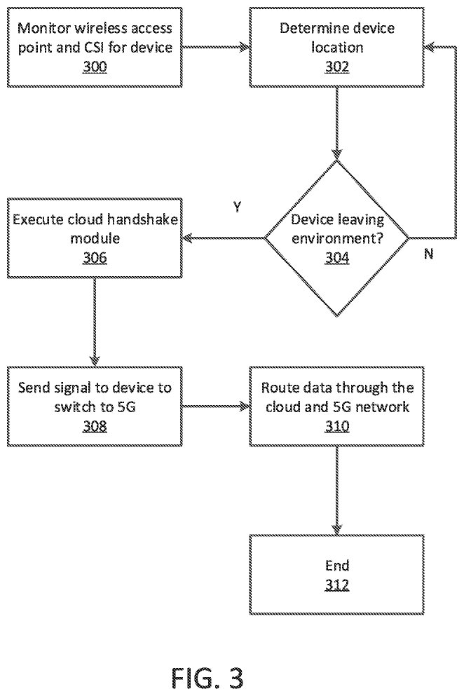

FIG. 3 is a flowchart illustrating an exemplary method for agent handshakes. The process begins at step 300 with the agent handshake module 122 monitoring the wireless access point 102 and the CSI data to determine a location of a mobile device 136 within the detection environment of the Wi-Fi motion detection system. The Wi-Fi motion detection system can determine the location of objects or users by monitoring CSI data from the wireless access point 102 at step 302. The user can be identified based on the user CSI signature. The location of said objects or users can also be determined as their CSI signatures change based on their location and proximity to the wireless access point 102. The Wi-Fi motion detection system can further be configured or trained to map an environment such as the interior of a building. When the location of an object or user is detected, the detected location can be mapped to the detection environment. Based on the determined location of the object, in this case a mobile device 136, the system at step 304 can determine if the mobile device 136 is leaving the Wi-Fi motion detection environment (e.g., leaving the building).

If the mobile device 136 has not left the building, the agent handshake module 122 goes to step 302 and continues to monitor the location of the mobile device 136 until the mobile device 136 does leave the detection environment. In one embodiment, the system may determine a mobile device 136 has exited the detection environment based on its current location such as outside of the building. In another embodiment, the signal strength may be the indicator that the mobile device 136 is leaving the detection environment. The system may determine that once a mobile device 136 is far enough away from the access point 102 and the signal had sufficiently diminished to the point where other means of data transfer and communication may be more reliable and faster (i.e., 5G). If the mobile device 136 has been determined to have left or leaving the detection environment, the cloud handshake module 134 is then executed at step 306. This allows the system to begin to connect and communicate with the mobile device 136 over the cloud 5G network.

Once it has been determined that a device 136 has left the detection environment a signal is sent to the mobile device handshake module 142 to tell the mobile device 136 that the mobile device 136 is leaving the Wi-Fi motion detection environment and to switch over to 5G at step 308. The mobile device 136 then begin monitoring the location and transmitting data via 5G rather than Wi-Fi. The wireless access point 102 then begins to send data and track the location of the mobile device 136 through a 5G connection through the cloud 126 at step 310. Once the data has switched and the system is communicating with the mobile device 136 through the cloud 126, the agent handshake module 122 ends at step 312.

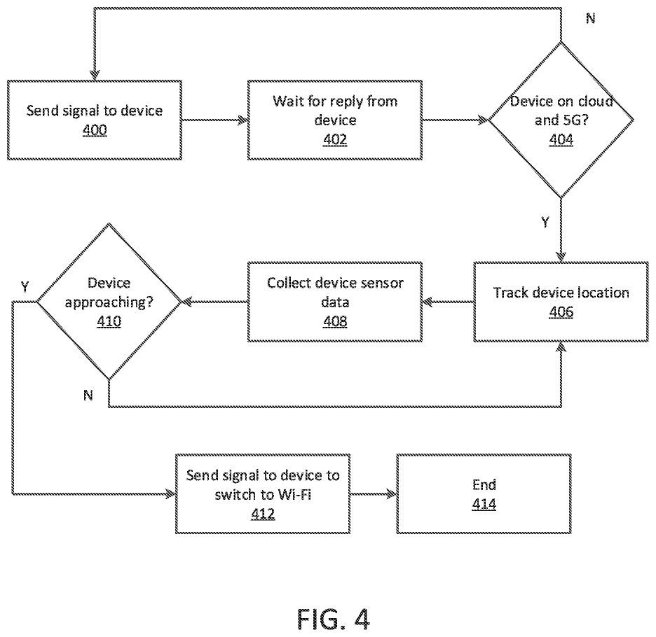

FIG. 4 is a flowchart illustrating an exemplary method for cloud handshakes. The process begins at step 400 with cloud handshake module 134 sending a signal out over the cloud 126 and 5G network to identify and locate the mobile device 136 that just left the Wi-Fi motion detection environment. The cloud handshake module 134 may then wait for a predetermined period of time for a reply from the mobile device 136 to ensure that the mobile device 136 is on the 5G network and has left the Wi-Fi detection environment at step 402. At step 404, if after the predetermined period of time, there is no reply from the mobile device 136, the module may go back to step 400, and the signal may be sent again. If a signal is sent to the mobile device 136 more than a predetermined number of times (e.g., 5 attempts), the module may go to step 414 and end with the idea that the mobile device 136 could not be reached or was not connected to the network. If a reply from the mobile device 136 is received at step 404, the cloud handshake module 134 then begins to receive and track the position of the mobile device 136 or location at step 406. The location can be from GPS data from the mobile device 136 or through triangulation using cellular data.

Data from other sensors 148 associated with mobile device 136 is then received at step 408 and can be stored in the cloud 126 on a database or sent back to the agent 114 and stored on a database, such as the mobile device database 124. Once the data is collected, the location of the mobile device 136 is determined and compared to the location of the Wi-Fi motion detection environment and determines if the mobile device 136 is getting close to about to enter the detection environment at step 410. If the mobile device 136 is not near or about to enter the detection environment, then the cloud handshake module 134 goes back to step 406 and continues to track the location of the mobile device 136 and collect sensor data via sensors 148. If the mobile device 136 is entering or nearing the Wi-Fi detection environment, then a signal is sent to the mobile device 136 to switch over to the Wi-Fi detection environment at step 412. In another embodiment, the mobile device 136 may be able to detect its own location and initiate the switch between the 5G network and the Wi-Fi motion detection environment without a signal from the cloud handshake module 134 or the agent handshake module 122. Once the signal has been sent to the mobile device 136 to switch to the Wi-Fi motion detection environment, the cloud handshake module 134 then ends at step 414.

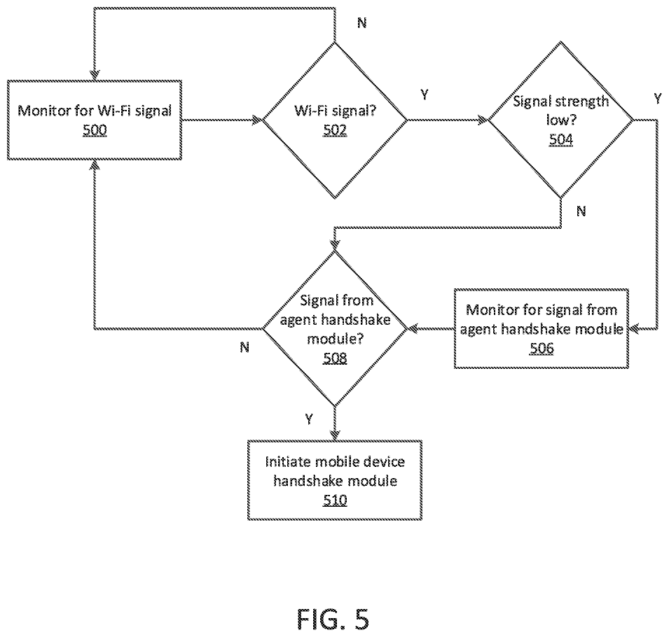

FIG. 5 is a flowchart illustrating an exemplary mobile device method for Wi-Fi radio motion detection. The process begins at step 500 with monitoring the Wi-Fi signal strength to determine the Wi-Fi motion detection environment. If the signal drops below a certain threshold, it can be determined that the mobile device 136 is moving away from the access point 102 and the Wi-Fi motion detection environment. Furthermore, this step can also be used to determine if there is a Wi-Fi signal present as a mobile device 136 approaches a Wi-Fi motion detection environment. If no signal is present at step 502, then it is assumed that the mobile device 136 is outside the Wi-Fi motion detection environment and the mobile device base module 140 goes back to step 500 and continues to monitor Wi-Fi signal strength. If there is a Wi-Fi signal present that is not below a low threshold at step 504, then the mobile device base module 140 continues then check for a signal from the agent handshake module 122 at step 506. The Wi-Fi signal may not be below a certain threshold, but the Wi-Fi motion detection system may have determined that the mobile device 136 is leaving the detection environment. If the Wi-Fi signal is not low at step 504, then the mobile device base module 140 monitors for a signal from the agent handshake module 122 at step 508. If there is no signal from the agent handshake module 122 at step 508, then the mobile device base module 140 returns to step 500 and monitors the Wi-Fi signal. If the Wi-Fi signal is low, such low Wi-Fi signal suggests that the mobile device 136 is leaving the Wi-Fi motion detection environment. Additionally, if there is a signal from the agent handshake module 122 at step 508, the agent handshake module 122 may have detected that the mobile device 136 is leaving the detection environment before the Wi-Fi signal strength drops to a low level and initiates the mobile device handshake module 142 at step 510. Once the mobile device handshake module 142 is initiated, the mobile device base module 140 continues to monitor for the Wi-Fi signal of the Wi-Fi motion detection environment. The mobile device base module 140 continues to monitor for the Wi-Fi signal in case the mobile device 136 enters the detection environment again.

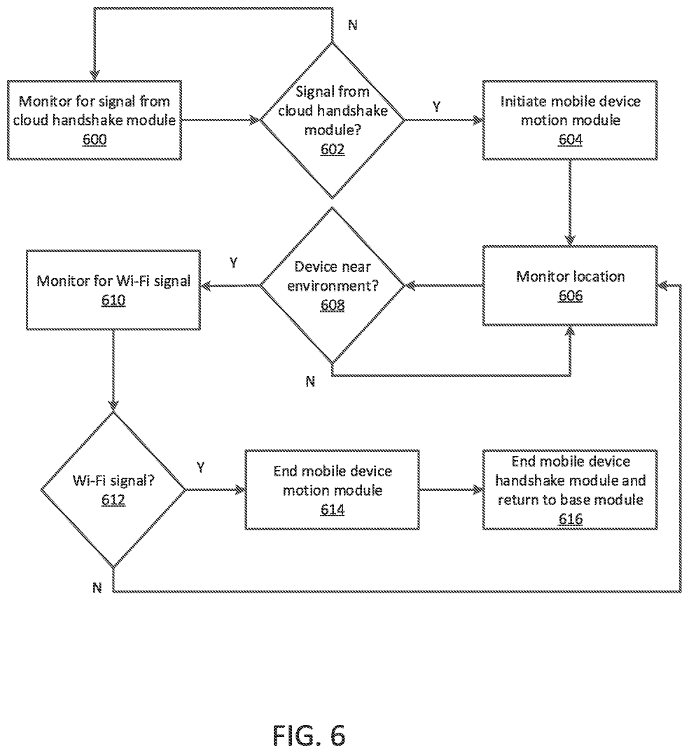

FIG. 6 is a flowchart illustrating an exemplary method for mobile device handshakes. The process begins with the mobile device handshake module 142 monitoring for a signal from the cloud handshake module 134 at step 600. If a signal is not received from the cloud handshake module 134 at step 602, the mobile device handshake module 142 continues to monitor for the signal. If a signal is received from the cloud handshake module 134 at step 602, the mobile device motion module 144 is initiated, which begins collecting sensor data from the sensors 148 at step 604. Once the mobile device motion module 144 is initiated, the mobile device handshake module 142 begins to monitor and collect the location of the mobile devices at step 606. Location data can be determined from GPS data or cellular location. The location of the mobile device 136 is then checked at step 608 to determine if the mobile device 136 is getting near the Wi-Fi motion detection environment. If the mobile device 136 is not near or entering into the Wi-Fi motion detection environment, then the mobile device handshake module 142 goes back to step 606 and continues monitoring the location of the mobile device. If the mobile device 136 is near or entering the environment, the mobile device handshake module 142 at step 610 begins to monitor to see if the mobile device 136 had detected the Wi-Fi motion detection environment. In some cases, the GPS or other location methods may not be accurate or the mobile device 136 may pick up the Wi-Fi signal before the location data determines that the mobile device 136 has entered the Wi-Fi motion detection environment. If no Wi-Fi signal is detected at step 612, the mobile device handshake module 142 goes back to step 606 and continues to monitor the location of the mobile device 136. If the location data determines that Wi-Fi signal is present, then the mobile device motion module 144 is ended at step 614. Once mobile device motion module 144 ends, the mobile device handshake module 142 is ends and returns to the base module 120 at step 616.

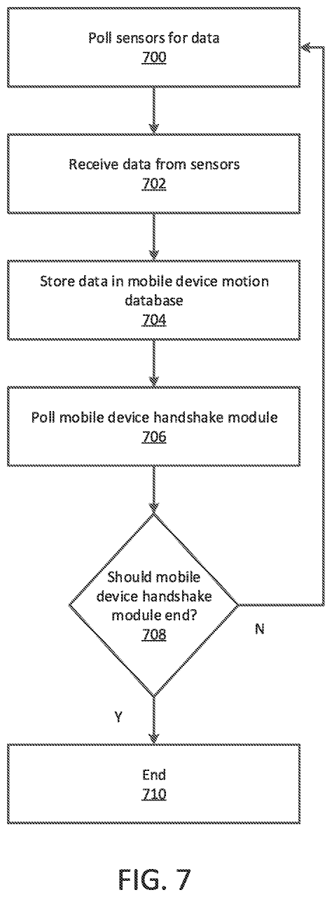

FIG. 7 is a flowchart illustrating an exemplary method for mobile device motion analysis. The process begins with the polling of the sensors 148 for sensor data at step 700. Sensor data may include but is not limited to accelerometer, temperatures, optical, or audio sensor data. The mobile device motion module 144 receives the data from the sensors 148 at step 702. The received data is then stored in the mobile device motion database 146 at step 704 and is stored there and can be sent to the cloud handshake module 134. In one embodiment, the received sensor data may be the 5G CSI data from the mobile devices 136. The received 5G CSI data from the mobile device 136 can then be processed locally or sent to the cloud 126 to determine activity. The mobile device motion module 144 then polls the mobile device handshake module 142 at step 706 for a command or signal to end. The command to end may mean that the mobile device 136 has entered a Wi-Fi motion detection environment. If there is no command or signal to end at step 708, then the mobile device motion module 144 goes back to step 700 and continues to poll the sensors 148 on the mobile device 136 for data. If a command or signal is received to end at step 708, then the module ends at step 710.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for detecting location, the method comprising:
detecting a mobile device connected to a Wi-Fi access point located within a detection environment;
determining that the mobile device is connectable to a 5G network based on information polled from the mobile device;
registering the mobile device within a database in memory, wherein registering the mobile device includes storing the information polled from the mobile device;
sending a signal to the mobile device via at least one of the Wi-Fi access point and the 5G network; and
determining a location of the mobile device within the detection environment based on data from the mobile device responsive to the signal.

2. The method of claim 1, wherein the information registered in the database includes one of a device model, a unique identifier (ID), MAC address, a user name of a user, and whether the user opted in for mobile device tracking.

3. The method of claim 1, further comprising identifying that the mobile device is leaving the detection environment.

4. The method of claim 3, wherein identifying that the mobile device is leaving the detection environment is based on an associated Wi-Fi signal strength falling below a predetermined threshold.

5. The method of claim 3, further comprising prompting the mobile device to connect to the 5G network based on identifying that the mobile device is leaving the detection environment.

6. The method of claim 1, wherein the data from the mobile device includes at least one of GPS data, accelerometer data, temperature data, optical data, audio data, and channel state information (CSI).

7. The method of claim 1, further comprising:
identifying when the mobile device is approaching the detection environment; and
sending a signal to the mobile device to connect to the Wi-Fi access point located within the detection environment.

8. The method of claim 1, further comprising identifying a type of activity being engaged in by a user of the mobile device based on the data from the mobile device.

9. The method of claim 8, wherein identifying the type of activity is based on identifying a pattern within the data from the mobile device.

10. The method of claim 1, further comprising storing the data from the mobile device in memory in association with historical data from the mobile device.

11. A system for detecting location, the system comprising:
a wireless access point located within a detection environment, wherein the wireless access point detects a connection to a mobile device;
a processor that executes instructions stored in memory, wherein the processor executes instructions to determine that the mobile device is connectable to a 5G network based on information polled from the mobile device;
memory that stores a database, wherein the database registers the mobile device within a database in memory, wherein registering the mobile device is based on information polled from the mobile device; and
a communication interface that sends a signal to the mobile device via at least one of the Wi-Fi access point and the 5G network,
wherein the processor determines a location of the mobile device within the detection environment based on data from the mobile device responsive to the signal.

12. The system of claim 11, wherein the information registered in the database includes one of a device model, a unique identifier (ID), MAC address, a user name of a user, and whether the user opted in for mobile device tracking.

13. The system of claim 11, wherein the processor executes further instructions to identify that the mobile device is leaving the detection environment.

14. The system of claim 13, wherein the processor identifies that the mobile device is leaving the detection environment based on an associated Wi-Fi signal strength falling below a predetermined threshold.

15. The system of claim 13, wherein the communication interface further sends a prompt to the mobile device to connect to the 5G network based on the identification that the mobile device is leaving the detection environment.

16. The system of claim 11, wherein the data from the mobile device includes at least one of GPS data, accelerometer data, temperature data, optical data, audio data, and channel state information (CSI).

17. The system of claim 11, wherein the processor executes further instructions to identify when the mobile device is approaching the detection environment, and wherein the communication interface sends a signal to the mobile device to connect to the Wi-Fi access point located within the detection environment.

18. The system of claim 11, the processor executes further instructions to identify a type of activity being engaged in by a user of the mobile device based on the data from the mobile device.

19. The system of claim 18, wherein the processor identifies the type of activity based on identifying a pattern within the data from the mobile device.

20. The system of claim 11, wherein the memory further stores the data from the mobile device in memory in association with historical data from the mobile device.

21. A non-transitory, computer-readable storage medium, having embodied thereon a program executable by a processor to perform a method for detecting location, the method comprising:
detecting a mobile device connected to a Wi-Fi access point located within a detection environment;
determining that the mobile device is connectable to a 5G network based on information polled from the mobile device;
registering the mobile device within a database in memory, wherein registering the mobile device includes storing the information polled from the mobile device;
sending a signal to the mobile device via at least one of the Wi-Fi access point and the 5G network; and
determining a location of the mobile device within the detection environment based on data from the mobile device responsive to the signal.
